(19) United States
(12) Patent Application Publication
(10) Pub. No.: US 2014/0055281 A1
(43) Pub. Date: Feb. 27, 2014

(54) SERVER AND METHOD FOR MANAGING GREENHOUSE GAS EMISSIONS INVESTIGATIONS

(71) Applicant: HON HAI PRECISION INDUSTRY CO., LTD., New Taipei (TW)

(72) Inventor: Ya-Fen WENG, New Taipei (TW)

(73) Assignee: HON HAI PRECISION INDUSTRY CO., LTD., New Taipei (TW)

(21) Appl. No.: 13/858,099

(22) Filed: Apr. 8, 2013

(30) Foreign Application Priority Data
Aug. 27, 2012 (CN) 2012103067485

(51) Int. Cl. G01D 4/00

(52) U.S. Cl. CPC G01D 4/002
USPC 340/870.02

(57) ABSTRACT

In a method for managing greenhouse gas emissions investigations, collected data of greenhouse gas emissions is received from one or more computing devices and checked. An amount of CO₂ emitted from each of one or more emission sources is calculated according to the collected data, statistical analysis is implemented to the calculation result, a report is created according to the statistical analysis, and the report is transmitted to the one or more computing devices.

### BACKGROUND

1. Technical Field

Embodiments of the present disclosure generally relate to data management technology, and particularly to a server and a method for managing greenhouse gas emissions investigations.

2. Description of Related Art

To control and reduce emissions of greenhouse gases, many companies request their providers (who provide products, raw materials, parts or accessories, for example, to the companies) to investigate greenhouse gases emitted from industrial factories. However, it is a waste of time and manpower to transmit e-mails or call the providers for following up the greenhouse gas emissions investigations. Besides, because a massive amount of data about the greenhouse gases needs to be collected and calculated, it is difficult to manage the collected data manually.

### BRIEF DESCRIPTION OF THE DRAWINGS

FIG. 1 is a schematic diagram of one embodiment of a management server.

FIG. 2 is a block diagram of one embodiment of function modules of a management unit of the management server in FIG. 1.

FIG. 3 is a flowchart of one embodiment of a method for managing greenhouse gas emissions investigations.

FIG. 4 is a flowchart detailing one embodiment of step S16 in FIG. 3.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

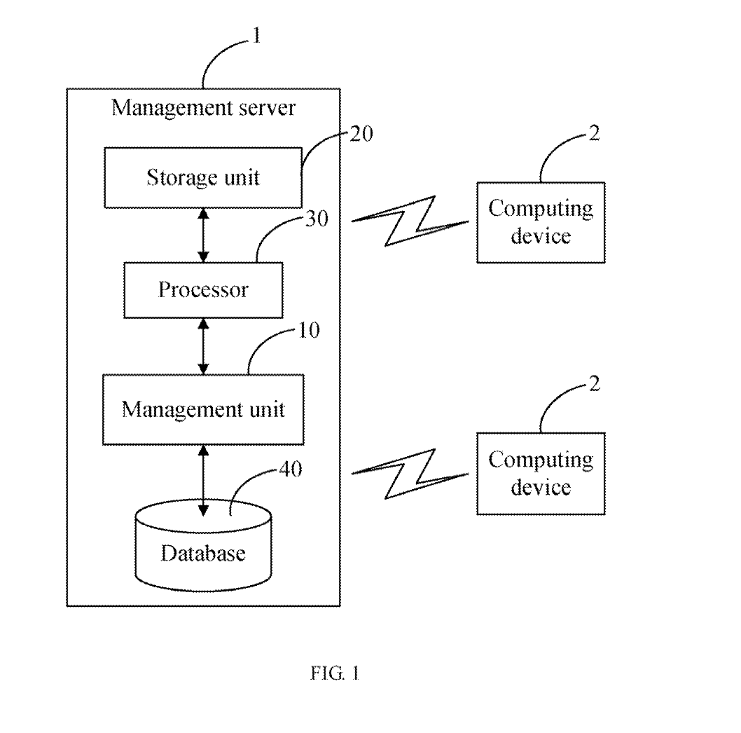

FIG. 1 is a schematic diagram of one embodiment of a management server 1. In the embodiment, the management server 1 includes a management unit 10, a storage unit 20, a processor 30, and a database 40. The management server 1 is electrically connected to one or more computing devices 2 (two are shown in FIG. 1).

The management unit 10 manages greenhouse gas emissions investigations for providers of a company. The providers input collected data of the greenhouse gas emissions into the computing devices 2, and the collected data is transmitted to the management server 1 by the computing devices 2. In detail, the management unit 10 checks and analyzes the collected data, and transmits analysis results to the computing devices 2.

The database 40 includes a provider database, a greenhouse gas (GHG) database, and a green data collection platform (GDCP) database. The provider database stores data about the providers, for example, names and e-mail addresses of the providers. In the embodiment, the collected data may be transmitted to the management server 1 by the computing devices 2 via an online mode or an offline mode. The online mode expresses that the collected data is transmitted to the management server 1 via the Internet, a wireless or non-wireless transmission method, or via BLUETOOTH. The offline mode expresses that the collected data is transmitted to the management server 1 by an electronic attachment, for example. The GHG database stores the collected data, which are transmitted to the management server 1 by the computing devices 2 via the online mode, and checking results and analysis results of the collected data. The GDCP database stores the collected data, which are transmitted to the management server 1 by the computing devices 2 via the offline mode.

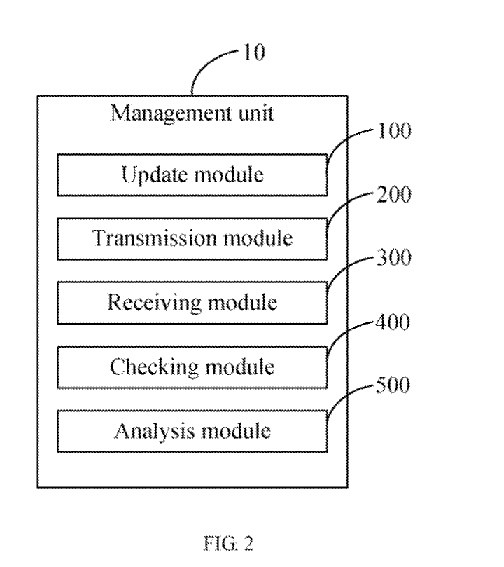

In one embodiment, the management unit 10 may include one or more function modules (as shown in FIG. 2). The one or more function modules may comprise computerized code in the form of one or more programs that are stored in the storage unit 20, and executed by the processor 30 to provide the functions of the management unit 10. The storage unit 20 is a dedicated memory, such as an EPROM or a flash memory.

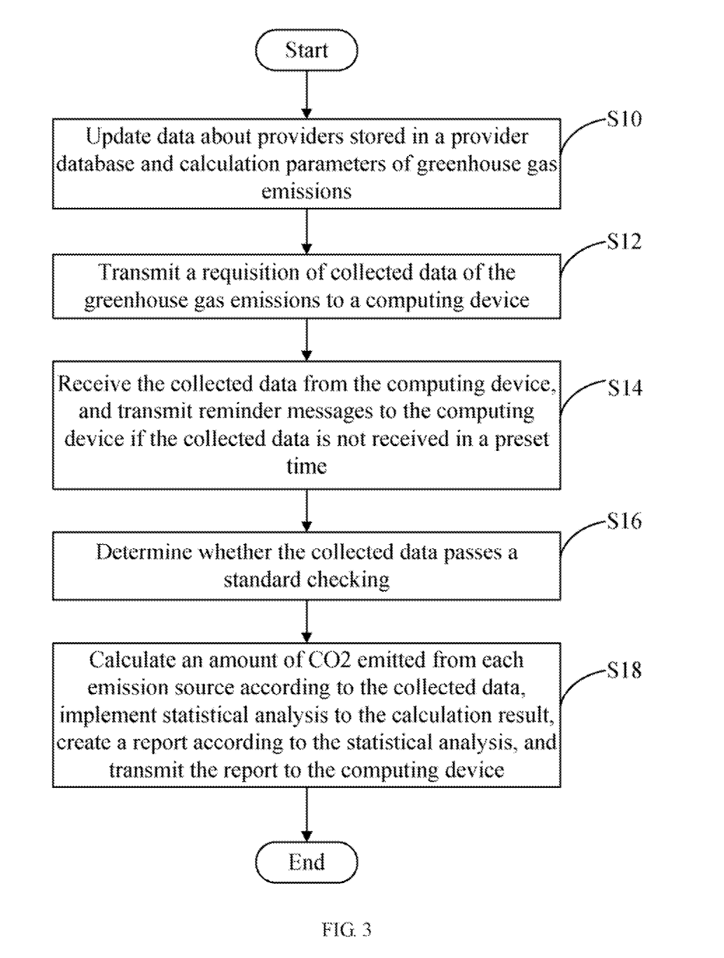

FIG. 2 is a block diagram of one embodiment of the function modules of the management unit 10. In one embodiment, the management unit 10 includes a update module 100, a transmission module 200, a receiving module 300, a checking module 400, and an analysis module 500. A description of the functions of the modules 100-500 is given with reference to FIG. 3.

FIG. 3 is a flowchart of one embodiment of a method for managing greenhouse gas emissions investigations. Depending on the embodiment, additional steps may be added, others removed, and the ordering of the steps may be changed, all steps are labeled with even numbers only.

In step S10, the update module 100 updates data about providers stored in a provider database and calculation parameters of the greenhouse gas emissions. If a provider has a new e-mail address, for example, the update module 100 updates the e-mail address of the provider stored in the provider database. In the embodiment, the calculation parameters include emission sources, emission coefficients, global warming potential (GWP) coefficients, and types of greenhouse gases, for example. The update module 100 may copy the emission coefficients, the GWP coefficients, or the types of the greenhouse gases from historical data of last year. The update module 100 may further automatically acquire the emission coefficients and GWP coefficients from the intergovernmental panel on climate change (IPCC).

The emission sources may be a baking varnish device or a car, for example, which use raw materials (e.g., gasoline, electric energy) emitting the greenhouse gases. The emission coefficients express relationships between the greenhouse gases and the emission sources. For example, the emission coefficient may be an amount of CO₂ emitted when one liter of gasoline is burned. The greenhouse gases emitted include CO₂, CH₄, N₂O, HFCs, PFCs, and SF₆.

In step S12, the transmission module 200 transmits a requisition of the collected data of the greenhouse gas emissions to the computing device 2. In the embodiments, the computing device 2 transmits the requisition to corresponding computing device 2 according to a selected year of the greenhouse gas emissions investigation, a selected factory region and a selected e-mail addresses of the provider, to inform the provider to collect data of the greenhouse gas emissions in the selected year.

In step S14, the receiving module 300 receives the collected data of the greenhouse gas emissions from the computing device 2, and the transmission module 200 transmits reminder messages to the computing device 2 if the receiving module 300 does not receive the collected data in a preset time. For example, the transmission module 200 may transmit a reminder e-mail to the provider at a specified time.

If the collected data are transmitted to the management server 1 by the computing devices 2 via the online mode, the receiving module 300 stores the collected data in the GHG database. If the collected data are transmitted to the management server 1 by the computing devices 2 via the offline mode, the receiving module 300 stores the collected data in the GDCP database, and the collected data are copied and stored to the GHG database when the collected data are submitted to checking.

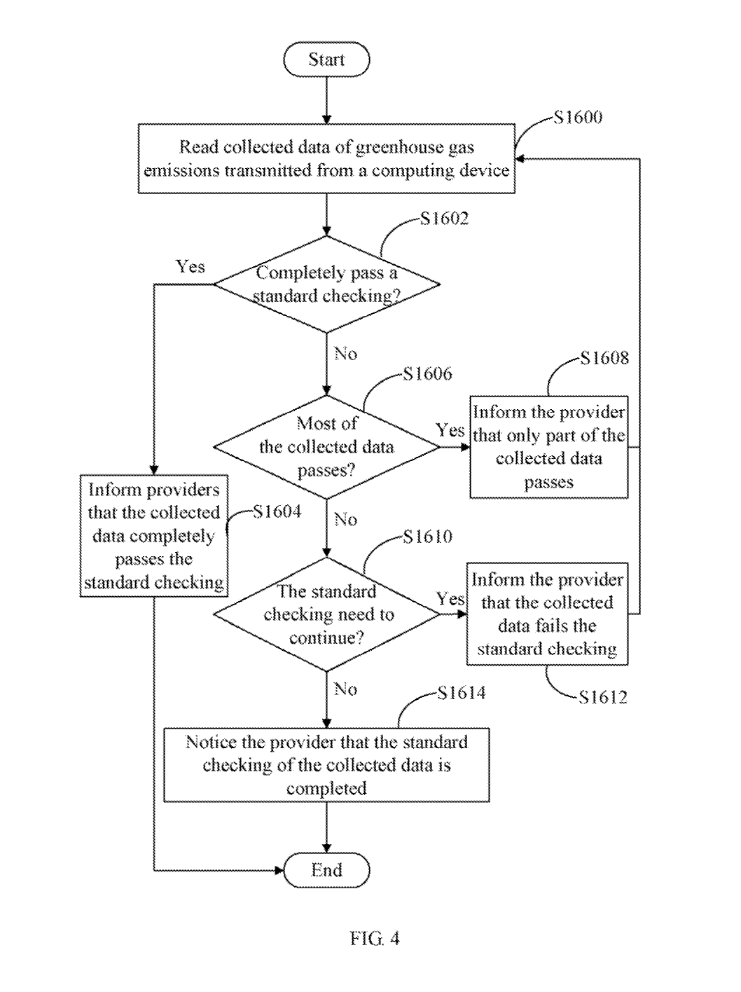

In step S16, the checking module 400 determines whether the collected data passes a standard checking. In the embodiment, the standard checking includes checking a format, a collecting time, an organization boundary, and an emission boundary of the collected data. If the collected data is in a preset format, and is collected in a preset collecting time, a preset organization boundary, and a preset emission boundary, the checking module 400 determines the collected data passes the standard checking. A description is given below with reference to FIG. 4.

In the embodiment, the collected data may be in an EXCEL format. The collecting time may be a year, or a month, for example. The organization boundary is a range of the greenhouse gases emitted by an organization of the provider, such as a factory or a department of the factory. The emission boundary is an emission type applicable to the factory region of the provider, including direct emissions, indirect emissions from energy, and other indirect emissions.

In step S18, the analysis module 500 calculates an amount of CO₂ emitted from each emission source according to the collected data, implements statistical analysis to the calculation result, creates a report according to the statistical analysis, and transmits the report to the computing device 2.

The analysis module 500 calculates the amount of CO₂ emitted from the emission source according to a collected amount of the raw materials of the emission source, and the emission coefficient and the GWP coefficient of each greenhouse gas emitted from the raw materials. The amount of CO₂ emitted from the emission source equals an emitted amount of each greenhouse gas multiplied by the GWP coefficient of the greenhouse gas. The emitted amount of each greenhouse gas equals the collected amount of the raw materials multiplied by corresponding emission coefficient of the greenhouse gas.

For example, a collected amount of the raw materials emitting greenhouse gases of a baking varnish device (as a emission source) is 15.0 kilograms. The greenhouse gases emitted include CO₂ and CH₄, where the emission coefficient of CO₂ is 0.863, the emission coefficient of CH₄ is 0.0025, the GWP coefficient of CO₂ is 1, and the GWP coefficient of CH₄ is 1. The analysis module 500 calculates that the amount of CO₂ emitted from the baking varnish device is 15.0*0.863*1+15.0*0.0025*1=13.32 kilograms.

In the embodiment, the statistical analysis includes six types of the greenhouse gases, three types of the emission boundary, four types of the emission sources, and a trend of the CO₂ emissions in a year. The emission sources include fixed emission sources, moving emission sources, dissipating emission sources, and process emission sources. The report may include tables, graphs, maps, or other types of presentation.

FIG. 4 is a flowchart detailing one embodiment of step S16 in FIG. 3. Depending on the embodiment, additional steps may be added, others removed, and the ordering of the steps may be changed, all substeps progressing in even numbers only.

In step S1600, the checking module 400 reads the collected data of the greenhouse gas emissions transmitted from the computing device 2.

In step S1602, the checking module 400 determines whether the collected data completely passes a standard checking. If the collected data completely passes the standard checking, step S1604 is implemented. If the collected data does not completely pass the standard checking, step S1606 is implemented.

In step S1604, the transmission module 200 transmits the checking result to the computing device 2, to inform the provider that the collected data completely passes the standard checking.

In step S1606, the checking module 400 determines whether most (e.g., 90%) of the collected data passes the standard checking. If most of the collected data passes the standard checking, step S1608 is implemented. If most of the collected data does not pass the standard checking, step S1610 is implemented.

In step S1608, the transmission module 200 transmits the checking result to the computing device 2, to inform the provider that only part of the collected data passes the standard checking, amend or supplement to the collected data is required.

In step S1610, the checking module 400 determines whether the standard checking need to continue. In the embodiment, if the greenhouse gas emissions investigation temporarily need not to collect the data of the greenhouse gas emissions, the standard checking need not to continue. If the standard checking need to continue, step S1612 is implemented. If the standard checking need not to continue, step S1614 is implemented.

In step S1612, the transmission module 200 transmits the checking result to the computing device 2, to inform the provider that the collected data fails the standard checking, and require the provider to submit the collected data again.

In step S1614, the transmission module 200 transmits the checking result to the computing device 2, so as to notice the provider that the standard checking of the collected data is completed.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method being executed by a processor of an electronic device electrically connected to one or more computing devices, the method comprising:
(a) receiving collected data of greenhouse gas emissions from the one or more computing devices;
(b) determining whether the collected data passes a standard checking; and
(c) calculating an amount of CO₂ emitted from each of one or more emission sources according to the collected data, implementing statistical analysis to the calculation result, creating a report according to the statistical analysis, and transmitting the report to the one or more computing devices.

2. The method as claimed in claim 1, wherein before step (a) the method further comprises:
updating data about providers and calculation parameters of the greenhouse gas emissions, wherein the calculation parameters comprise the one or more emission sources, emission coefficients, global warming potential (GWP) coefficients, and types of greenhouse gases.

3. The method as claimed in claim 1, wherein step (a) further comprises:
transmitting reminder messages to the one or more computing devices in response that the collected data is not received in a preset time.

4. The method as claimed in claim 1, wherein:
the collected data transmitted to the electronic device by the one or more computing devices via an online mode is stored in a first database of the electronic device; and
the collected data transmitted to the electronic device by the one or more computing devices via an offline mode is stored in a second database of the electronic device.

5. The method as claimed in claim 1, wherein in step (c):
the amount of CO2 emitted from the emission source equals an emitted amount of each greenhouse gas multiplied by the GWP coefficient of the greenhouse gas; and
the emitted amount of each greenhouse gas equals a collected amount of raw materials of the emission source multiplied by corresponding emission coefficient of the greenhouse gas.

6. The method as claimed in claim 1, wherein in step (c), the statistical analysis comprises six types of the greenhouse gases, three types of emission boundary, four types of the emission sources, and a trend of the CO2 emissions in a year.

7. A non-transitory storage medium storing a set of instructions, the set of instructions being executed by a processor of an electronic device electrically connected to one or more computing devices, to perform a method comprising:
(a) receiving collected data of greenhouse gas emissions from the one or more computing devices;
(b) determining whether the collected data passes a standard checking; and
(c) calculating an amount of CO₂ emitted from each of one or more emission sources according to the collected data, implementing statistical analysis to the calculation result, creating a report according to the statistical analysis, and transmitting the report to the one or more computing devices.

8. The non-transitory storage medium as claimed in claim 7, wherein before step (a) the method further comprises:
updating data about providers and calculation parameters of the greenhouse gas emissions, wherein the calculation parameters comprise the one or more emission sources, emission coefficients, global warming potential (GWP) coefficients, and types of greenhouse gases.

9. The non-transitory storage medium as claimed in claim 7, wherein step (a) further comprises:
transmitting reminder messages to the one or more computing devices in response that the collected data is not received in a preset time.

10. The non-transitory storage medium as claimed in claim 7, wherein:
the collected data transmitted to the electronic device by the one or more computing devices via an online mode is stored in a first database of the electronic device; and
the collected data transmitted to the electronic device by the one or more computing devices via an offline mode is stored in a second database of the electronic device.

11. The non-transitory storage medium as claimed in claim 7, wherein in step (c):
the amount of CO2 emitted from the emission source equals an emitted amount of each greenhouse gas multiplied by the GWP coefficient of the greenhouse gas; and
the emitted amount of each greenhouse gas equals a collected amount of raw materials of the emission source multiplied by corresponding emission coefficient of the greenhouse gas.

12. The non-transitory storage medium as claimed in claim 7, wherein in step (c), the statistical analysis comprises six types of the greenhouse gases, three types of emission boundary, four types of the emission sources, and a trend of the CO2 emissions in a year.

13. An electronic device electrically connected to one or more computing devices, the electronic device comprising:
a storage unit;
at least one processor;
one or more programs that are stored in the storage unit and are executed by the at least one processor, the one or more programs comprising:
a receiving module that receives collected data of greenhouse gas emissions from the one or more computing devices;
a checking module that determines whether the collected data passes a standard checking; and
an analysis module that calculates an amount of CO2 emitted from each of one or more emission sources according to the collected data, implements statistical analysis to the calculation result, creates a report according to the statistical analysis, and transmits the report to the one or more computing devices.

14. The electronic device as claimed in claim 13, wherein the one or more programs further comprises:
a update module that updates data about providers and calculation parameters of the greenhouse gas emissions, wherein the calculation parameters comprise the one or more emission sources, emission coefficients, global warming potential (GWP) coefficients, and types of greenhouse gases.

15. The electronic device as claimed in claim 13, wherein the transmission module further transmits reminder messages to the one or more computing devices in response that the receiving module does not receive the collected data in a preset time.

16. The electronic device as claimed in claim 13, wherein:
the collected data transmitted to the electronic device by the one or more computing devices via an online mode is stored in a first database of the electronic device; and
the collected data transmitted to the electronic device by the one or more computing devices via an offline mode is stored in a second database of the electronic device.

17. The electronic device as claimed in claim 13, wherein:
the amount of CO2 emitted from the emission source equals an emitted amount of each greenhouse gas multiplied by the GWP coefficient of the greenhouse gas; and
the emitted amount of each greenhouse gas equals a collected amount of raw materials of the emission source multiplied by corresponding emission coefficient of the greenhouse gas.

18. The electronic device as claimed in claim 13, wherein the statistical analysis comprises six types of the greenhouse gases, three types of emission boundary, four types of the emission sources, and a trend of the CO2 emissions in a year.
